(19) United States
(12) Patent Application Publication
(10) Pub. No.: US 2012/0326844 A1
(43) Pub. Date: Dec. 27, 2012

(54) RADIO-FREQUENCY IDENTIFICATION (RFID) TAG EVENT OCCURRENCE DETECTION, REPORTING, AND MONITORING, AND RELATED RFID READERS, SYSTEMS, AND METHODS

(76) Inventors: Vincent B. Blaignan, Corning, NY (US); James Patrick Trice, Corning, NY (US); Richard Edward Wagner, Painted Post, NY (US); Dale Alan Webb, Corning, NY (US); Matthew Scott Whiting, Lawrenceville, PA (US)

(21) Appl. No.: 13/566,228

(22) Filed: Aug. 3, 2012

Related U.S. Application Data
(63) Continuation-in-part of application No. 12/956,271, filed on Nov. 30, 2010.
Application No. 12/956,271 is a continuation-in-part of application No. 11/590,377, filed on Oct. 31, 2006.

(51) Int. Cl. G06K 7/01; G06K 19/073

(52) U.S. Cl. 340/10.1; 235/492; 235/439

(57) ABSTRACT

Disclosed herein are radio-frequency identification (RFID) tag event occurrence detection, generation, and monitoring. Related components, RFID readers, systems, and methods are also disclosed. The RFID tags are configured to sense an event(s) that occurred in the RFID tag or in proximity thereto. In response, the RFID tags are configured to set an event occurrence indicator(s) in a memory of the RFID tag indicating the occurrence of the sensed event(s). A RFID reader is configured to perform a query of a population of RFID tags in communication range to detect which RFID tags have a set event occurrence indicator(s), so a RFID reader can then specifically communiate with RFID tags that experienced an event(s) to request and service the event(s) type without having to perform those same operations for the entire RFID tag population. The RFID reader can be configured to take desired actions based on detection of events.

### PRIORITY APPLICATIONS

The present application is a continuation-in-part patent application of co-pending U.S. application Ser. No. 11/590,377 filed on Oct. 31, 2006 and entitled “Radio Frequency Identification Transponder For Communicating Condition Of A Component,” which is incorporated herein by reference in its entirety.

The present application is also a continuation-in-part patent application of co-pending U.S. patent application Ser. No. 12/956,271 filed on Nov. 30, 2010 and entitled “RFID Condition Latching,” which is incorporated herein by reference in its entirety.

### RELATED APPLICATIONS

The present application is also related to application Ser. No. 11/590,505, now U.S. Pat. No. 7,782,202, filed on Oct. 31, 2006 and entitled “Radio Frequency Identification Of Component Connections,” which is incorporated herein by reference in its entirety.

The present application is also related to application Ser. No. 11/590,513, now U.S. Pat. No. 7,772,975, filed on Oct. 31, 2006 and entitled “System for Mapping Connections Using RFID Function,” which is incorporated herein by reference in its entirety.

### BACKGROUND

1. Field of the Disclosure

The technology of the disclosure is related to radio-frequency (RF) identification (RFID) tags or transponders, including passive RFID tags, and RFID antennas.

2. Technical Background

Radio-frequency (RF) identification (RFID) devices or transponders can be employed to identify articles of manufacture. RFID transponders are also often referred to as “RFID tags.” For example, a RFID system could be provided that includes one or more RFID tag. The RFID tags may include RF circuitry in the form of an integrated circuit (IC) chip that is communicatively coupled to an antenna. The IC chip may also be coupled to memory. An identification number or other characteristic is stored in the IC or memory coupled to the IC. The identification number can be provided to another system, such as the RFID reader, to provide identification information for a variety of purposes.

If the RFID tag is an “active” tag having a transmitter, the RFID tag can transmit the identification information to the RFID reader. An active RFID tag contains its own power source, which is typically a battery, for powering a transmitter in an active RFID tag. In contrast, if the RFID tag is a “passive” tag, the RFID tag does not contain its own power source. Power to operate a passive RFID tag is received through energy contained in a wireless RF signal received by the RFID tag antenna. The wireless RF signal is transmitted by a transmitter in the RFID reader. A passive RFID tag harvests energy from the electro-magnetic field of the wireless RF signal to provide power to the IC for a passive RFID tag operation. A passive RFID tag can respond to receipt of the wireless RF signal. A passive RFID tag can then respond to the RFID reader, including providing identification information stored in the passive RFID tag, via backscatter modulation communications, as an example. In either case of a passive or active RFID tag, the RFID reader may store information received from the RFID tag in a database and/or report the information to other systems outside the RFID system.

It may be desirable to provide a RFID system that can detect events for a plurality of RFID tags. It may be desired to detect these RFID tag events as they occur. In this example, the RFID tags may be equipped with event detection capability. For example, events may include connection of the RFID tag to another electrical component, connection of a connector housing the RFID tag to another connection, or activating a switch associated with the RFID tag, as non-limiting examples. Events may also include detecting environmental conditions, including but not limited to temperature, pressure, humidity, or light exposures, as non-limiting examples. Some conditions, including environmental conditions, may require the RFID tags to be equipped with a condition event sensor capable of detecting the condition. A RFID reader provided in the RFID system communicates with the entire RFID tag population to determine which RFID tags detected an event and the type of event that occurred.

### SUMMARY OF THE DETAILED DESCRIPTION

Embodiments disclosed in the detailed description include radio-frequency identification (RFID) tag (transponder) event occurrence detection, generation, and monitoring. Related components, RFID readers, systems, and methods are also disclosed. In one embodiment, each of the RFID tags are configured to sense one or more events (“event(s)”) that occurred in the RFID tag or in proximity to the RFID tag. In response, each of the RFID tags is configured to set one or more event occurrence indicators (“event occurrence indicator(s)”) in a memory of the RFID tag indicating the occurrence of the one or more sensed event(s) associated with such RFID tag. Each RFID tag may also be configured to store information about the event(s) associated with the RFID tag in the memory of the RFID tag. A RFID reader is configured to perform a general query or interrogation of a population of RFID tags in communication range of the RFID reader to detect which RFID tags have set event occurrence indicator(s). In this manner, a RFID reader can then specifically communicate with each of the RFID tags that has experienced an event(s) to request and service the event(s) type and/or other related information associated with the RFID tag without having to perform those same operations for the entire RFID tag population. The RFID reader can be configured to take desired actions based on detection of events. The RFID reader can be configured to acknowledge the event(s) to the RFID tags that sensed the event(s) so the RFID tag can clear the event occurrence indicator(s) associated with that RFID tag. Each of the RFID tags may also be configured to detect multiple events in such a way that the RFID reader is configured to retrieve and distinguish between the multiple events associated with each of the RFID tags.

In this regard in one embodiment, a radio-frequency identification (RFID) tag is provided. The RFID tag comprises an integrated circuit (IC). The RFID tag also comprises an antenna electrically coupled to the IC, the antenna configured to receive wireless RF signals. The RFID tag also comprises a memory accessible to the IC, the memory comprising one or more event occurrence indicators. One or more event sensors are electrically coupled to the IC and configured to sense an occurrence of one or more events and indicate the occurrence of the one or more events to the IC. The IC is configured to set the one or more event occurrence indicators in response to occurrence of the one or more events.

In another embodiment, a method of a radio-frequency identification (RFID) tag reporting an event occurrence relating to the RFID tag is provided. The method comprises sensing an occurrence of one or more events in one or more event sensors electrically coupled to an integrated circuit (IC) of a RFID tag. The method also comprises indicating the occurrence of the one or more events to the IC. The method also comprises setting one or more event occurrence indicators in a memory accessible to the IC in response to the occurrence of the one or more events.

In another embodiment, a radio-frequency identification (RFID) reader is provided. The RFID reader comprises a controller electrically coupled to a transmitter, the controller configured to control the transmitter to transmit wireless RF signals through an antenna electrically coupled to the transmitter. The RFID reader also comprises a memory accessible to the controller. The controller is configured to send a query requesting event occurrence indicator status from a plurality of RFID tags. The controller is also configured to receive at least one reply from a subset of RFID tags among the plurality of RFID tags, each of the plurality of RFID tags having one or more event occurrence indicators set indicative of an occurrence of one or more events associated with a respective RFID tag. The controller is also configured to request event occurrence information from the subset of RFID tags that have at least one of the one or more event occurrence indicators set.

In another embodiment, a method of a radio-frequency identification (RFID) reader reading event occurrences from RFID tags is provided. The method comprises wirelessly sending a query from a transmitter electrically coupled to an antenna requesting event occurrence indicator status from a plurality of RFID tags. The method also comprises receiving at least one reply from a subset of RFID tags among the plurality of RFID tags having one or more event occurrence indicators set indicative of an occurrence of one or more events. The method also comprises requesting event occurrence information from the subset of RFID tags having at least one event occurrence indicator set among the one or more event occurrence indicators for the RFID tag.

In another embodiment, a radio-frequency identification (RFID) system is provided. The RFID system comprises a plurality of RFID tags. Each of the plurality of RFID tags comprises an integrated circuit (IC). At least one event sensor is electrically coupled to the IC and configured to sense the occurrence of one or more events and indicate the occurrence of the one or more events to the IC. The IC is configured to set the one or more event occurrence indicators in response to occurrence of the one or more events. The IC is also configured to report a status of the one or more event occurrence indicators to a RFID reader. The RFID system also comprises a RFID reader. The RFID reader comprises a controller electrically coupled to a transmitter, the controller configured to control the transmitter to transmit wireless RF signals through an antenna. The controller is configured to send a query requesting event occurrence indicator status from the plurality of RFID tags. The controller is also configured to receive at least one reply from the plurality of RFID tags indicating whether at least one or more event occurrence indicators for the RFID tag is set. If the one or more event occurrence indicators is set, the controller is also configured to request event occurrence information from a subset of the plurality of RFID tags that have at least one event occurrence indicator set among the one or more event occurrence indicators for the RFID tag. It is noted that various RFID tags in a subset of RFID tags may have different event occurrence indicators set from other RFID tags in the subset of RFID tags. Some RFID tags may be configured or capable of sensing events that are not associated with or sensed by other RFID tags. Various RFID tags may also have the same event occurrence indicators set as other RFID tags in the subset of RFID tags. For example, some RFID tags may sense the same event as other RFID tags.

Additional features and advantages will be set forth in the detailed description which follows, and in part will be readily apparent to those skilled in the art from that description or recognized by practicing the embodiments as described herein, including the detailed description that follows, the claims, as well as the appended drawings.

It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF THE FIGURES

FIG. 1 is a schematic diagram of an exemplary RFID system illustrating an RFID reader in communication with an RFID tag;

FIG. 2 is a schematic diagram of an exemplary RFID system illustrating a RFID reader communicating with a plurality of RFID tags in the communication field of the RFID reader;

FIG. 3 is a schematic diagram of an exemplary passive RFID tag employing a capacitance bank to store energy for RFID tag operations;

FIG. 4 is a schematic diagram of an exemplary generalized RFID tag related event occurrence detection sequence performed in an exemplary RFID system that includes exemplary event occurrence detection, and reporting, and monitoring of the event;

FIG. 5 is a schematic diagram of a more detailed version of the exemplary RFID tag event occurrence detection sequence in FIG. 4;

FIG. 6A is a schematic diagram of an exemplary RFID tag event and occurrence memory map;

FIG. 6B is an exemplary RFID tag event occurrence formula for determining if a RFID related tag event should be reported;

FIG. 7 is a schematic diagram of another exemplary RFID tag event and occurrence memory map;

FIG. 8 is a schematic diagram of another exemplary RFID tag event detection sequence performed by an exemplary RFID system having a plurality of RFID tags in the field of a RFID reader, where a single RFID tag event occurrence is detected by a RFID tag and the corresponding RFID related tag event is reported to the RFID reader;

FIG. 9 is an exemplary low level reader protocol (LLRP) event table that may be employed by the RFID reader in the RFID system in FIG. 8 to support monitoring a single RFID related tag event for each reported RFID tag;

FIGS. 10A and 10B are schematic diagrams of another exemplary RFID tag event detection sequence performed in an exemplary RFID system having a plurality of RFID tags in the field of a RFID reader, where multiple RFID tag event occurrences are detected by a RFID tag and the corresponding RFID related tag events are reported to the RFID reader, wherein the RFID tag events are cleared in the RFID tag one at a time;

FIGS. 11A and 11B are schematic diagrams of another exemplary RFID tag event detection sequence performed in an exemplary RFID system having a plurality of RFID tags in the field of a RFID reader, where multiple RFID tag event occurrences are detected by a RFID tag and the corresponding RFID tag related events are reported to the RFID reader, wherein the RFID tag events are cleared in the RFID tag contemporaneously; and

FIG. 12 is an exemplary low level reader protocol (LLRP) event table that may be employed by the RFID reader in the RFID system in FIGS. 11A and 11B to support monitoring multiple RFID tag events for each reported RFID tag.

### DETAILED DESCRIPTION

Reference will now be made in detail to the embodiments, examples of which are illustrated in the accompanying drawings, in which some, but not all embodiments are shown. Indeed, the concepts may be embodied in many different forms and should not be construed as limiting herein; rather, these embodiments are provided so that this disclosure will satisfy applicable legal requirements. Whenever possible, like reference numbers will be used to refer to like components or parts.

Embodiments disclosed in the detailed description include radio-frequency identification (RFID) tag (transponder) event occurrence detection, generation, and monitoring. Related components, RFID readers, systems, and methods are also disclosed. In one embodiment, each of the RFID tags are configured to sense one or more events (“event(s)”) that occurred in the RFID tag or in proximity to the RFID tag. In response, each of the RFID tags is configured to set one or more event occurrence indicators (“event occurrence indicator(s)”) in a memory of the RFID tag indicating the occurrence of the one or more sensed event(s) associated with such RFID tag. Each RFID tag may also be configured to store information about the event(s) associated with the RFID tag in the memory of the RFID tag. A RFID reader is configured to perform a general query or interrogation of a population of RFID tags in communication range of the RFID reader to detect which RFID tags have set event occurrence indicator(s). In this manner, a RFID reader can then specifically communicate with each of the RFID tags that has experienced an event(s) to request and service the event(s) type and/or other related information associated with the RFID tag without having to perform those same operations for the entire RFID tag population. The RFID reader can be configured to take desired actions based on detection of events. The RFID reader can be configured to acknowledge the event(s) to the RFID tags that sensed the event(s) so the RFID tag can clear the event occurrence indicator(s) associated with that RFID tag. Each of the RFID tags may also be configured to detect multiple events in such a way that the RFID reader is configured to retrieve and distinguish between the multiple events associated with each of the RFID tags.

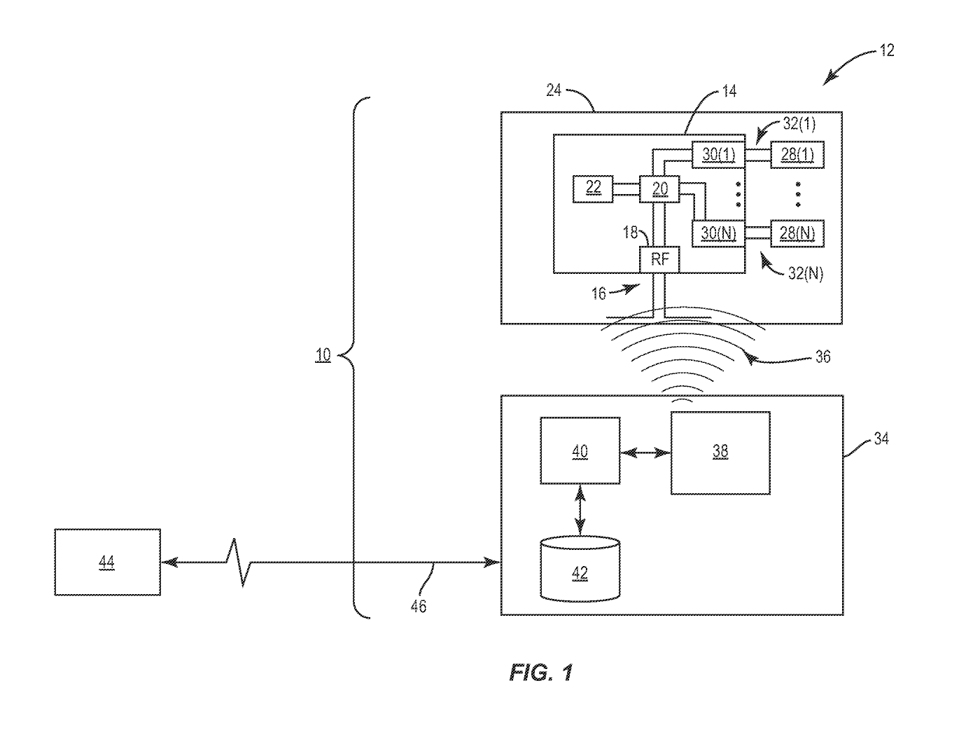

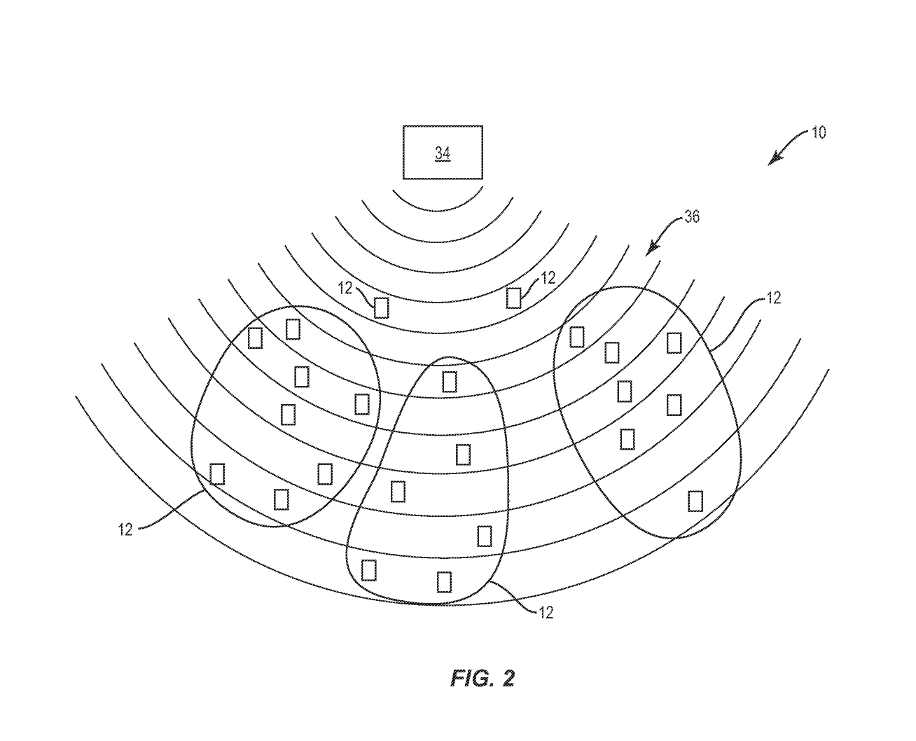

In this regard, FIG. 1 is a schematic diagram of an exemplary RFID system 10 that includes a RFID tag 12 that is configured to sense an event(s) that occurred in the RFID tag 12 or in proximity to the RFID tag 12. Only one RFID tag 12 is illustrated in the RFID system 10 of FIG. 1, but note that a plurality of RFID tags 12 may be located in the RFID system 10, as illustrated in FIG. 2. With reference back to FIG. 1, the RFID tag 12 includes an integrated circuit (IC) 14 that may be provided in an electronic chip and that is communicatively coupled to an antenna 16 for wireless communications. The RFID tag 12 may include a RF interface 18 that is provided as part of the IC 14 to provide an interface between the antenna 16 and control circuitry 20 provided in the IC 14 that controls operations of the RFID tag 12. The IC 14 may also be coupled to memory 22. Memory 22 may be included in the IC 14 as shown in FIG. 1, or provided external to the IC 14 and coupled to the IC 14 in the RFID tag 12. The RFID tag 12 may be included in a body 24 or other enclosure, which may also be attached or associated with an article of manufacture as a non-limiting example.

With continuing reference to FIG. 1, the RFID tag 12 is configured to set an event occurrence indicator(s) in memory 22 indicating the occurrence of a sensed event(s). As will be discussed in more detail below, an event occurrence indicator is a flag or indicia that allows another system to detect that one or more events has occurred and been sensed by the RFID tag 12. Thus, it will be known by other systems that one or more events occurred in the RFID tag 12 or in proximity of the RFID tag 12. Each RFID tag 12 is capable of detecting and reporting the occurrence of single events or multiple different types of events associated with the RFID tag 12. As will be discussed in more detail below, the event types for sensed events and information related to the sensed events can then be retrieved based on detection that one or more event occurrence indicators are present in the memory 22 of the RFID tag 12. Without the event occurrence indicators configured to be stored by the IC 14 in the memory 22 of the RFID tag 12, the RFID tag 12 would have to be interrogated without knowing whether an event associated with the RFID tag 12 has occurred or not.

An identification indicia and/or other information can also be stored in memory 22. The sensed events and/or information stored in memory 22 can be provided to another system, such as the RFID reader 34 illustrated in FIGS. 1 and 2, for a variety of purposes including to process a sensed event(s) by the RFID tag 12 as will be discussed in more detail below. In this regard, the RFID tag 12 includes one or more event sensors 28(1)-28(N) configured to sense events associated with the RFID tag 12 or in proximity to the RFID tag 12. The event sensors 28(1)-28(N) are shown in FIG. 1 as being external to the IC 14 and electrically coupled to the IC 14. However, one or more of the event sensors 28(1)-28(N) could also be included within the IC 14. One or more ports 30(1)-30(N) are provided as part of the IC 14 to receive signals from the event sensors 28(1)-28(N).

With continuing reference to FIG. 1, the event sensors 28(1)-28(N) are configured to sense an occurrence of one or more events according to their intended design or purpose, and indicate the occurrence of the event to the IC 14. As one non-limiting example, any or all of the event sensors 28(1)-28(N) may be a digital device configured to provide digital information indicating whether an event has occurred or not occurred. When an event sensor 28(1)-28(N) is a digital device, it can act as the event sensor 28(1)-28(N), because the digital device can directly determine whether a condition has occurred or not occurred and provide digital information as to whether the condition has occurred or not occurred. As another non-limiting example, when an event sensor 28(1)-28(N) is an analog device, it may be combined a digital sensing element as part of the event sensor 28(1)-28(N). The digital sensing element can utilize condition information from the analog device, together with a predefined requirement or threshold(s), to determine if the predetermined requirement or threshold(s) has been satisfied or not satisfied.

With continuing reference to FIG. 1, the sensed events are communicated by the event sensors 28(1)-28(N) to the IC 14. A sensed event by a event sensor 28(1)-28(N) could be a non-tangible event type meaning an event internal to the RFID tag 12, such as a temperature of the RFID tag 12, or an error condition occurring in the RFID tag 12, as a non-limiting examples. A sensed event by a event sensor 28(1)-28(N) could also be a tangible event type, meaning an event that was manifested through an event occurring external to the RFID tag 12, such as an environmental condition as a non-limiting example.

Non-limiting examples of event types that may be sensed by the event sensors 28(1)-28(N) include the occurrence of the RFID tag 12 power up, a power outage, an error condition associated with the RFID tag 12 or any of its components, the RFID tag 12 connection to another RFID tag, a disconnect of the RFID tag 12 from another RFID tag, identification information exchange between the RFID tag 12 and another RFID tag, environmental conditions (e.g., temperature, humidity, altitude, orientation, etc.), a heartbeat timer, a contact closure, a switch activation, a switch deactivation, an analog signal threshold crossing, a digital input high, and a digital input low. The event sensors 28(1)-28(N) can be provided in the body 24 and can be any type of event sensor that is capable of sensing the desired event. As an example, a sensed event by the RFID tag 12 and stored in memory 22 allows the sensed event to be associated with an article of manufacture. As another example, identification indicia stored in the memory 22 of the RFID tag 12 allows an article of manufacture associated with the RFID tag 12 and any events sensed by the RFID tag 12 to be specifically identified by communication with the RFID tag 12.

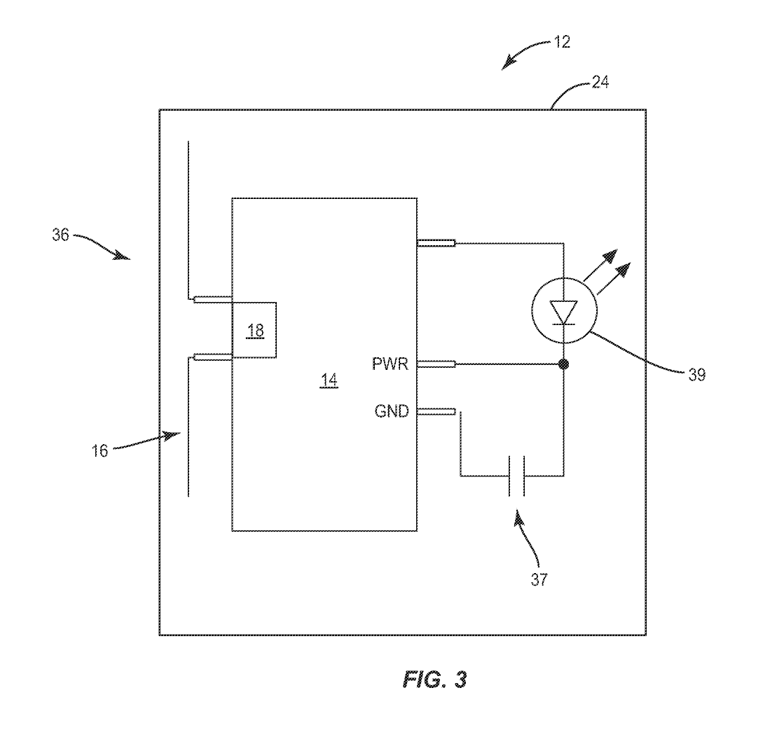

With continuing reference to FIG. 1, the RFID tag 12 can be an active tag or a passive tag. If the RFID tag 12 is an “active” tag, the RFID tag 12 will include a transmitter that transmits the identification information or other information stored in memory 22 to the RFID reader 34. An active RFID tag contains its own power source, which is typically a battery, for powering a transmitter. If, on the other hand, the RFID tag 12 is a “passive” tag, the RFID tag 12 does not contain its own active power source. Power to operate a passive RFID tag 12 is received through energy contained in a wireless RF signal 36 received by the antenna 16. Power received from the wireless RF signal 36 through the antenna 16 may be stored in a chargeable passive energy storage device 37 (e.g. a capacitor or capacitor bank), as illustrated in the RFID tag 12 in FIG. 3, for use in powering RFID tag 12 operations. The energy from the passive energy storage device 37 can be discharged, when desired, to provide power for RFID tag 12 operations when the wireless RF signal 36 is not being received. For example, the IC 14 may be configured to cause a visual indicator 39, such as a light emitting diode (LED), provided as part of the RFID tag 12, as illustrated FIG. 3, to be illuminated when an event is detected.

With reference back to FIG. 1, the wireless RF signal 36 is transmitted by a transmitter 38 under control of a controller 40 in the RFID reader 34. A passive RFID tag 12 harvests energy from the electro-magnetic field of the wireless RF signal 36 to provide power to the IC 14 for a passive RFID tag operation. A passive RFID tag 12 responds to receipt of the wireless RF signal 36, including providing sensed event, information identification information, and/or other information stored in memory 22, via backscatter modulation communications. In either case of a passive or active RFID tag 12, the RFID reader 34 may store this information retrieved from the RFID tag 12 in a database 42 and/or report the events to other systems 44 outside the RFID system 10 via a network link 46 or other communications link.

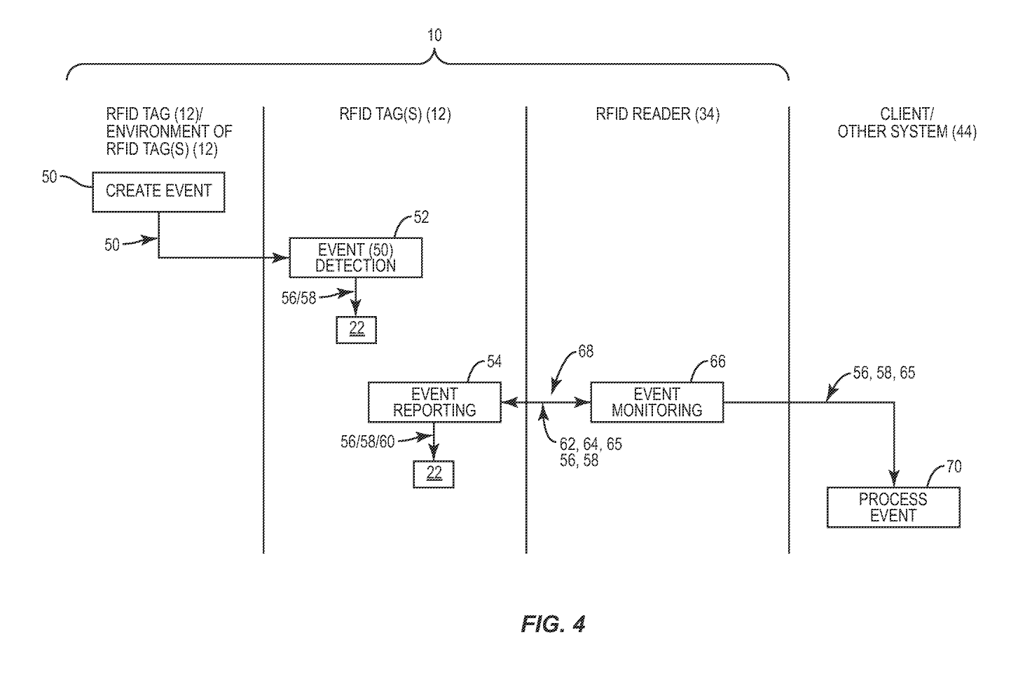

FIG. 4 is a schematic diagram of an exemplary generalized RFID tag event occurrence detection sequence that can be performed by the RFID system 10 in FIGS. 1 and 2. The RFID tag event occurrence detection sequence in FIG. 4 includes exemplary event occurrence detection, reporting, and monitoring of RFID tag related events. In this regard, one or more events 50 will occur and be created with respect to the RFID tag 12 or the environment of the RFID tag 12. The one or more event sensors 28(1)-28(N) in the RFID tag 12 will sense the event 50 and communicate event occurrence information in the form of event type 56 and/or other information 58 in this example relating to the event 50 to the IC 14 (block 52). As discussed previously, the IC 14 will report the detected event 50 in memory 22 (block 54). In response, the IC 14 can store the event type 56 and/or other information 58 relating to the event 50 in memory 22 for later retrieval. Non-limiting examples of other information 58 that may be detected and stored in association with a detected event 50 could include time or date of the occurrence of the event 50, data associated with the event 50, and an error condition. Other examples for signals include whether a signal crossed a threshold level and/or whether a digital signal is logical high or logical low, voltage level detection, timer values, or expirations. Other examples include contact closure events (e.g., open or closed) and identification information exchange.

With continuing reference to FIG. 4, in this embodiment, the IC 14 of the RFID tag 12 is also configured to flag the occurrence and detection of the detected event 50 by setting an event occurrence indicator 60 associated with the event type 56 in memory 22 (block 54). Setting an event occurrence indicator 60 may include the setting of an event occurrence indicator bit associated with an event type 56 in the memory 22 of the RFID tag 12, as a non-limiting example. The IC 14 is configured to set one or more event occurrence indicators 60 in memory 22 in response to occurrence and detection of one or more events sensed by the event sensors 28(1)-28(N) and communicated to the IC 14. The event occurrence indicator(s) 60 stored in memory 22 allow for the RFID reader 34 to interrogate the RFID tag 12 to determine whether any events 50 have occurred associated with RFID tag 12 and detected by the RFID tag 12.

Without the event occurrence indicators 60 configured to be set by the IC 14 in the memory 22 of the RFID tag 12, the RFID tag 12 would have to be interrogated specifically for event 50 information without the RFID reader 34 being able to determine whether an event 50 associated with the RFID tag 12 was detected. By providing the event occurrence indicator scheme in FIG. 4, the RFID reader 34 can perform a general query or interrogation of a population of RFID tags 12 (see FIG. 2) in communication range of the RFID reader 34 to detect which RFID tags 12 have set event occurrence indicators 60. In this manner, the RFID reader 34 can then specifically communicate with each RFID tag 12 that has experienced and detected an event 50 to request the event type(s) 56 and/or other related information 58 without having to perform those same operations for the entire RFID tag 12 population. The RFID reader 34 can interrogate the RFID tag 12, and specifically whether any event occurrence indicators 60 are set in the memory 22 of the RFID tag 12, to determine whether further interrogation should be performed to retrieve the event type 56 and/or the other information 58 associated with the detected event 50. Without the event occurrence indicators configured to be stored by the IC 14 in the memory 22 of the RFID tag 12, each RFID tag 12 would have to be interrogated by the RFID reader 34 for event 50 information without knowing whether an event associated with the RFID tag 12 has occurred or not.

With continuing reference to FIG. 4, the detected event types 56 and any other information 58 relating to the detected events 50 can then be retrieved by the RFID reader 34 from the RFID tag 12. In this regard, the RFID tag 12 may be configured to report a query reply 62 of any event occurrence indicators 60 set in memory 22 to the RFID reader 34 in response to an interrogation query 64 of the RFID tag 12 by the RFID reader 34 (block 66). An identification 65 of the RFID tag 12 is also provided to the RFID reader 34 associated with the query reply 62 so that the RFID reader 12 has knowledge of which RFID tags 12 have detected events 50 that have not been previously retrieved by the RFID reader 34. The RFID reader 34 uses this query reply 62 and identification 65 of the RFID tags 12 to subsequently interrogate only those RFID tags 12 among the population of RFID tags 12 that detected events 50.

With continuing reference to FIG. 4, the event types 56 and/or other information 58 related to the detected events 50 can subsequently be retrieved by the RFID reader 34 based on the query reply 62 indicating which RFID tags 12 had event occurrence indicators 60 set in memory 22 (block 66). The identification 65 of the RFID tag 12 stored in memory 22 may also be reported to the RFID reader 34 in association with interrogation of the event types 56 and/or other information 58 related to the detected events 50 so that the RFID reader 34 can associate the reported event types 56 and/or other information 58 relating the detected events 50 as occurring in association with a particular RFID tag 12.

As will be discussed in more detail below, the RFID reader 34 can be configured to take desired actions based on detection of events 50 that occurred relating to the RFID tags 12. The RFID reader 34 can be configured to provide an acknowledgement 68 of the event(s) 50 to the RFID tags 12 that detected the events 50 so the RFID tags 12 can clear the event occurrence indicator(s) 60 in their respective memory 22. Each RFID tag 12 may also be configured to detect multiple events 50 in such a way that the RFID reader 34 is configured to retrieve and distinguish between the multiple events 50. As will be also discussed in more detail below, the IC 14 of the RFID tag 12 can be configured to clear any set event occurrence indicators 60 in memory 22 in response to receipt of the acknowledgement 68 from the RFID reader 34 acknowledging the reporting and receipt of the detected events 50. Thereafter, as new occurrences of events 50 are sensed by the event sensors 28(1)-28(N) and detected by the RFID tags 12, the event occurrence indicators 60 can be set again in memory 22 to indicate the occurrence and detection of these new events 50 associated with the RFID tag 12 for interrogation of the query reply 62, and subsequent retrieval of the event type 56 and/or other information 58 by the RFID reader 34.

With continuing reference to FIG. 4, the RFID reader 34 may be configured to store the event type 56 and/or other information associated with a detected event 50 retrieved from the RFID tags 12 to the database 42 illustrated in FIG. 1. The RFID reader 34 may also be configured to report the reporting of the one or more events 50 from the RFID tags 12 to other systems. In this regard, with reference to FIG. 3, the RFID reader 34 may be configured to report the identification 65 of the RFID tag 12 that detected an event(s) 50 along with the event type(s) 56 and/or other information associated with the detected event(s) 50 retrieved from the RFID tags 12 to the other system(s) 44. The other system(s) 44 may be thought of as a client of the RFID system 10. The other system(s) 44 may then process the received detected events 50 for the RFID tags 12 as desired (block 70).

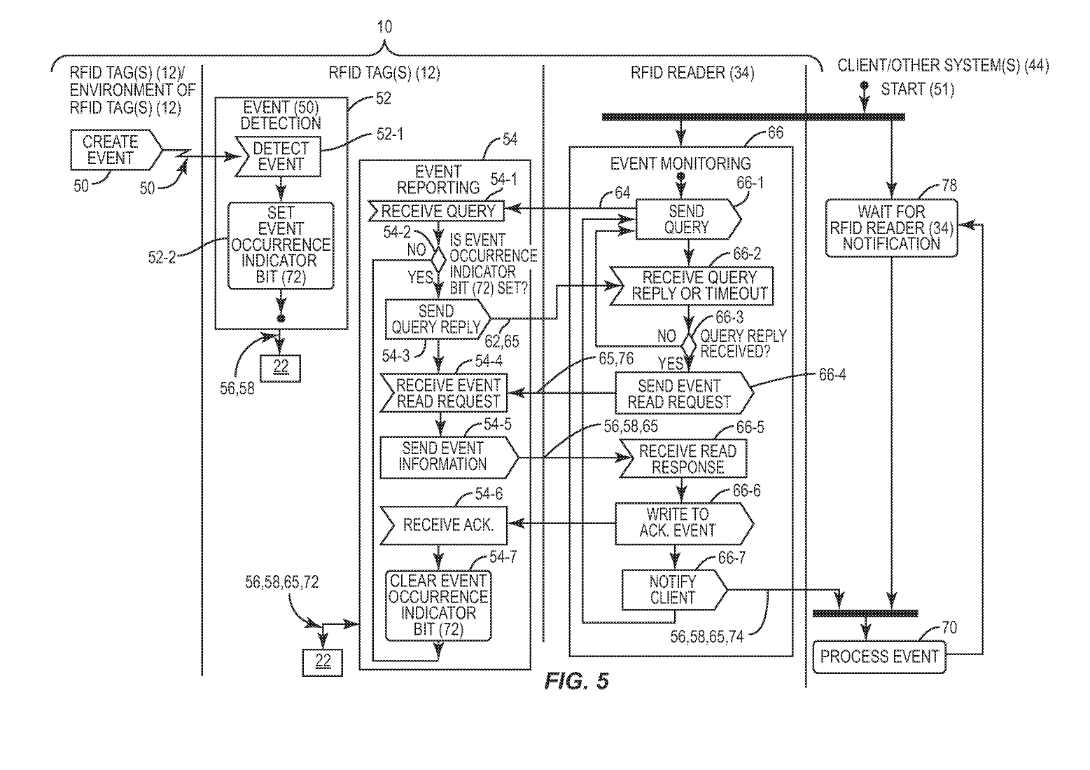

FIG. 5 is a schematic diagram of a more detailed version of the exemplary RFID tag event occurrence detection sequence in FIG. 4 to provide further exemplary features that may be provided to detect, monitor, and report the events 50 associated with the RFID tags 12. As discussed above with regard to FIG. 4, one or more events 50 will occur and be created with respect to the RFID tag 12 or the environment of the RFID tag 12. The one or more event sensors 28(1)-28(N) in the RFID tag 12 will sense the event 50 and communicate the event type 56 and/or other information 58 relating to the event 50 to the IC 14 (block 52-1). As discussed previously, the IC 14 will report the detected event 50 in memory 22 (block 52-1). In response, the IC 14 can store the event type 56 and/or other information 58 relating to the event 50 in memory 22 for later retrieval.

With continuing reference to FIG. 5, the RFID tag event occurrence detection scheme may not be initiated in the RFID reader 34 until a start command (task 51) is provided from the client 44 to the RFID reader 34, as an optional step. The IC 14 of the RFID tag 12 is also configured to flag the occurrence and detection of the detected event 50 by setting an event occurrence indicator 60 in the form of an event occurrence indicator bit 72 in memory 22 associated with the event type 56 in memory 22 (block 52-2). The detected event types 56 and any other information 58 relating to the detected events 50 can then be retrieved by the RFID reader 34 from the RFID tag 12. The event types 56 and/or other information 58 related to the detected events 50 can subsequently be retrieved by the RFID reader 34 based on the query reply 62 indicating which RFID tags 12 had event occurrence indicators 60 set in memory 22 (block 66). The RFID reader 34 sends the interrogation query 64 to the RFID tag 12 (block 66-1). As will be discussed in more detail below, the interrogation query 64 can request the RFID tag 12 to respond if any events 50 have occurred and been detected or if only a particular event 50 or events 50 have occurred and been detected. The RFID tag 12 receives the interrogation query 64 (block 54-1). The IC 14 of the RFID tag 12 determines if the event occurrence indicator bit 72 is set (block 54-2). If not, no response is sent by the RFID tag 12 to the RFID reader. If the event occurrence indicator bit 72 is set, the RFID tag 12 sends the query reply 62 to the RFID reader 34 along with the identification 65 of the RFID tag 12. The RFID reader 34 waits to receive the query reply 62 from the RFID tags 12 or times out waiting (block 66-2). If a query reply 62 is not received by a RFID tag 12 (block 66-3), the RFID reader 34 repeats by sending the interrogation query 64 (block 66-1).

With continuing reference to FIG. 5, if the RFID reader 34 receives the query reply 62 (block 66-3), the RFID reader 34 knows that an event 50 has occurred and been detected with regard to the RFID tag 12 identified by the identification 65 sent with the query reply 62 (block 54-3). The RFID reader 34 then sends an event read request n 76 with the identification 65 of the RFID tag 12 that reported the query reply 62 (block 66-4). This RFID tag 12 receives the event read request 76 from the RFID reader 34 (block 54-4). In response, the RFID tag 12 sends the detected event information 56, 58 to the RFID reader 34 along with the identification 65 of the RFID tag 12 so the RFID tag 12 can associate the detected event information 56, 58 with the particular RFID tag 12 (block 54-5). The RFID reader 34 receives the detected event information 56, 58 and the identification 65 of the RFID tag 12 in a read response (block 66-5). The RFID reader 34 then acknowledges the receipt of the event information 56, 58 for the RFID tag 12 identified by the identification 65 by sending the write to acknowledgement event 68 to the RFID reader 34 (block 66-6). For example, the write to acknowledgement event 68 may be written to the RFID tag 12 by the RFID reader 34 to a particular location in memory 22 of the RFID tag 12. As another example, the acknowledgement 68 may also be provided by the RFID reader 34 interrogating the RFID tag 12 to read a particular location in memory 22 of the RFID tag 12. The RFID tag 12 can be configured to interpret a read to a particular location in memory 22 as the write to acknowledgement event 68, which may consume less power than writing to memory 22 if memory 22 is non-volatile memory.

With continuing reference to FIG. 5, the RFID tag 12 receives the write to acknowledgement event 68 from the RFID reader 34 (block 54-6), wherein the RFID tag 12 then clears the event occurrence indicator bit 72 from memory 22 (block 54-7). In this manner, the RFID tag 12 will not set the event occurrence indicator bit 72 until another detected event 50 occurs that has not yet been reported to the RFID reader 34.

With continuing reference to FIG. 5, after the RFID reader 34 reports the write to acknowledgement event 68 to the RFID tag 12, the RFID reader 34 sends a notification 74 to the client or other system(s) 44 to provide the event information 56, 58 and the identification 65 of the associated RFID tag 12. The other system 44 waits for this notification 74 from the RFID reader 34 (block 78) until received, in which case the event information 56, 58 for the associated RFID tag 12 is processed (block 70). This can include storing the event information 56, 58 for the associated RFID tag 12 and/or reporting this information to other systems.

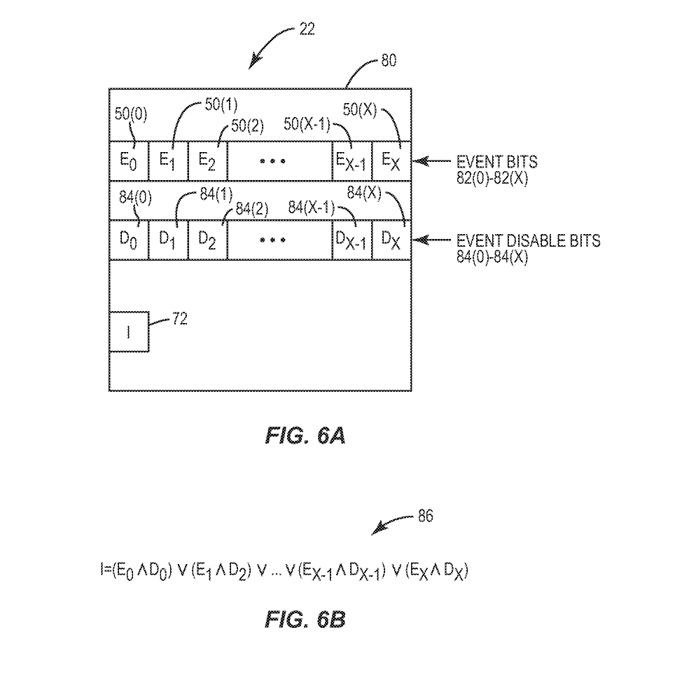

It may be desired to provide for the RFID tag 12 to be able to store different types of detected events 50 in memory 22. For example, event sensors 28(1)-28(N) may be provided in the RFID tag 12 that are configured to sense different types of events 50. In this regard, FIG. 6A is a schematic diagram of an exemplary occurrence memory map 80 that may be provided in memory 22 of a RFID tag 12 to allow for storage of event occurrence bits 72 for different types of detected events 50(0)-50(X), which is ‘X’ number of events in this example (‘X’ signifying any positive whole integer). In this regard, a single event occurrence indicator bit 72, designated by symbol I in the event occurrence interrupt bit 72 of FIG. 6A,s still only required to indicate that at least one event 50 has been detected in association with the RFID tag 12. However, a plurality of event detection indicators in the form of event bits 82(0)-82(X) are provided (i.e., designated as E₀-E_{X}) are provided in the memory 22. Each event bit 82(0)-82(X) represents the occurrence and detection of a particular event 50(0)-50(X) associated with the RFID tag 12 according to a predefined event bit 82 format. The detected event 50(0)-50(X) can be any of those discussed above as non-limiting examples. Each event bit 82(0)-82(X) may be located in a designated location to signify the event type 56 such that the RFID reader 34 can know which events 50 were detected without the memory 22 having to directly store an event type 56 in memory 22. The event bits 82(0)-82(X) will form a word that can be communicated by a RFID tag 12 as part of the event information 56, 58, as discussed above, and parsed by the RFID reader 34 to detect which events 50(0)-50(X) occurred and were detected in association with a RFID tag 12.

With continuing reference to FIG. 6A, the event occurrence memory map 80 may also contain event disable indicators in the form of event disable bits 84(0)-84(X) in this example (i.e., designated as D₀-D_{X}). The event disable bits 84(0)-84(X) are optional. The event disable bits 84(0)-84(X) are provided to correspond on a bit-for-bit basis with the event bits 82(0)-82(X). The event disable bits 84(0)-84(X) allow the RFID tag 12 to disable particular events 50(0)-50(X) from being set in the event bits 82(0)-82(X) in memory 22, even if sensed and detected by the RFID tag 12. The event occurrence indicator bit 72 will not be set in response to disabled events 50 occurring as designated by the event disable bits 84(0)-84(X). Thus, the RFID reader 34 will not, in effect, receive a report on any events 50 disabled according to the event disable bits 84(0)-84(X).

With continuing reference to FIG. 6A, if other events 50 occur that are not disabled in the event disabled bits 84(0)-84(X), the RFID reader 34 can parse and detect these events 50 as part of a word of the event bits 82(0)-82(X). In this regard, FIG. 6B is an exemplary RFID tag event occurrence formula 86 that can be provided in and used by the RFID tag 12 to determine if the event occurrence indicator bit 72(I) should be set. Setting the event occurrence indicator bit 72 means, in essence, that a detected event(s) 50 should be reported by the RFID tag 12 to the RFID reader 34 when interrogated. Thus, for example with regard to FIG. 5 described above, in response to the interrogation query 64 sent by the RFID reader 34 to the RFID tag 12, the event occurrence indicator bit 72 provides a single indication to the RFID tag 12 as to whether any events 50 have occurred and thus whether the RFID tag 12 should communicate the query reply 65. In this regard, each of the event bits 82(0)-82(X) are logically ANDed with each of their corresponding event disable bits 84(0)-84(X). Each result of the logical ANDing of the event bits 82(0)-82(X) and their corresponding event disable bits 84(0)-84(X) are logically ORed together. Thus, the event occurrence indicator bit 72 is set if any event 50(0)-50(X) has occurred and has been detected by the RFID tag 12, as set by any of the event bits 82(0)-82(X), and any such event bits 82(0)-82(X) are not disabled according to their corresponding event disable bits 84(0)-84(X).

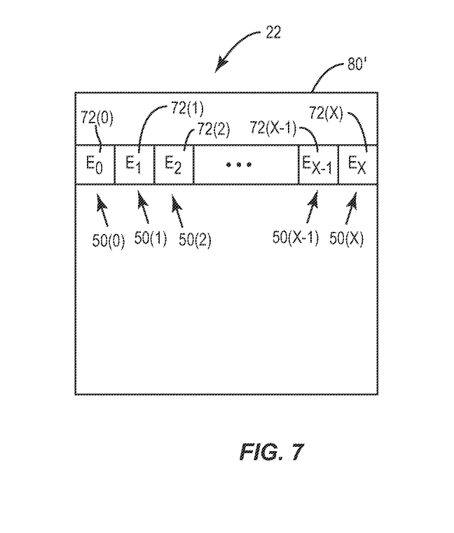

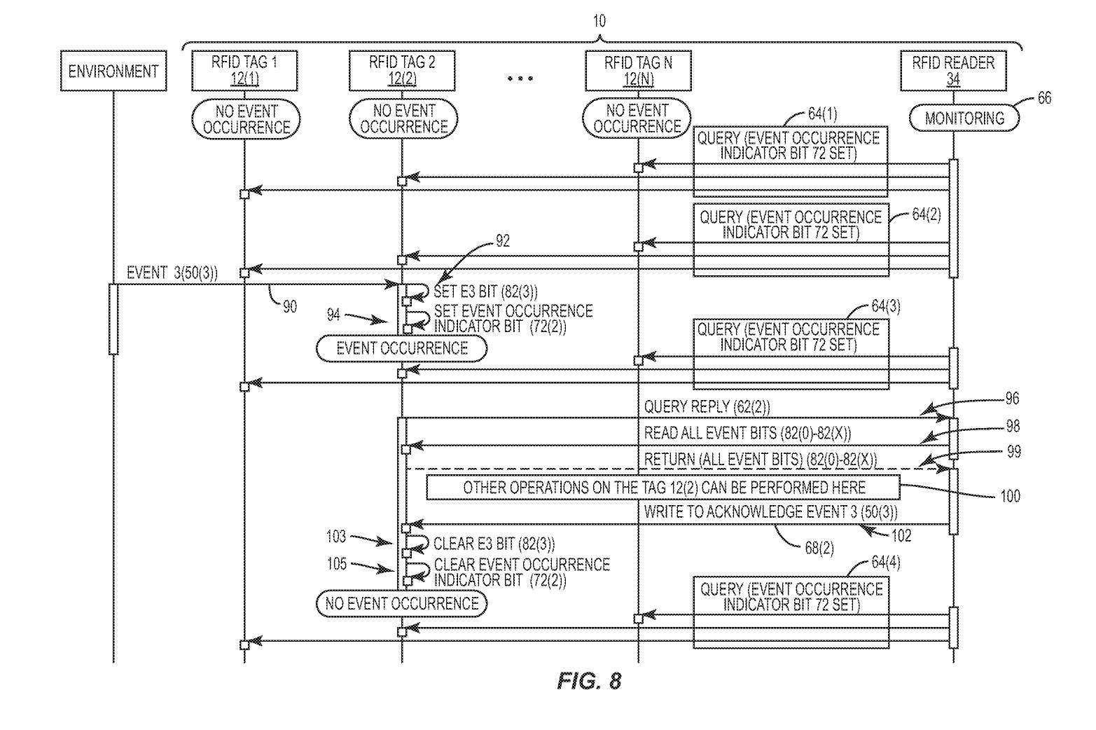

It is also possible to provide alternative data and/or memory structures to the event occurrence memory map 80 in FIG. 6A for storing different types of detected events 50 in memory 22. In this regard, FIG. 7 is a schematic diagram of an alternative exemplary event occurrence memory map 80′ that may be provided in memory 22 of a RFID tag 12. The event occurrence memory map 80′ stores a plurality of event occurrence indicator bits 72(0)-72(X) for each different event 50(0)-50(X) that can be detected by the RFID tag 12, wherein ‘X’ is the number of events in this example. In this regard, a plurality of event occurrence indicator bits 72(0)-72(X) are provided in memory 22, one bit for each event (i.e., designated as E₀-E_{X}). Each event occurrence indicator bit 72(0)-72(X) represents the occurrence and detection of a particular event 50(0)-50(X) associated with the RFID tag 12. Each event occurrence indicator bit 72(0)-72(X) may be located in a designated location in the event occurrence memory map 80′ to signify the event type 56 such that the RFID reader 34 can know which events 50(0)-50(X) were detected without the memory 22 having to directly store an event type 56 in memory 22.

Any of the event occurrence indicator bits 72(0)-72(X) being set means that a detected event(s) 50 should be reported by the RFID tag 12 to the RFID reader 34 when interrogated. If a particular event occurrence indicator bit 72(0)-72(X) is not set, this indicates the corresponding event E₀-E_{X} has not occurred since the last occurrence of such event, if any, was reported to a RFID reader 34. Particular event occurrence indicator bits 72(0)-72(X) can be interrogated to determine whether a particular event occurred and was detected for an interrogated RFID tag 12. Thus, for example with regard to FIG. 5 described above, if interrogation query 64 sent by the RFID reader 34 to the RFID tag 12 requests the RFID tag 12 to respond only if a particular event type(s) 56 has occurred and been detected, the particular event occurrence indicator bits 72(0)-72(X) corresponded to the requested event type(s) 56 can be reviewed by the RFID tag 12 to control the RFID tag 12 providing the query reply 65. The event occurrence indicator bits 72(0)-72(X) can also form a word that can be communicated by a RFID tag 12 as part of the event information 56, 58, as discussed above, and parsed by the RFID reader 34 to detect which events 50(0)-50(X) occurred and were detected in association with a RFID tag 12.

As discussed above, the RFID reader 34 can be configured to query and receive reports of events 50 from multiple RFID tags 12 in the communication range of the RFID reader 34. In this regard, FIG. 8 is a schematic diagram of another exemplary RFID tag event detection sequence performed in the RFID system 10. In this embodiment, a plurality of RFID tags 12 are in the field (i.e., communication range) of the RFID reader 34, such as illustrated in FIG. 2. The RFID reader 34 is configured to send an interrogation query 64 and receive a report of a single RFID tag event occurrence from one of the RFID tags 12 at a time, wherein the event 50 is reported to the RFID reader 34. Note that although FIG. 8 is described with regard to detecting and reporting a single event 50 associated with a single RFID tag 12, multiple events 50 from one or more RFID tags 12 can be detected and reported.

With reference to FIG. 8, the RFID reader 34 performs the monitoring of the RFID tags 12 (block 66) by sending out the interrogation query 64 to all the RFID tags 12 in communication range of the RFID reader 34. In this example, there are ‘N’ number of RFID tags 12(1)-12(N) in the field of the RFID reader 34, where ‘N’ is a positive whole integer. No query replies 62 are communicated by the RFID tags 12(1)-12(N) to the RFID reader 34 in response to interrogation queries 64(1) and 64(2) as illustrated in FIG. 8. This is because no events 50 have been detected by the RFID tags 12(1)-12(N) such that the event occurrence indicator bits 72(0)-72(N) in the RFID tags 12(1)-12(N), respectively, have been set, or the detected event 50 is disabled.

With continuing reference to FIG. 8, after the second interrogation query 64(2) is sent by the RFID reader with no query replies 62, an event 50 (e.g., event type 3 (event 50(3)) occurs in association with the RFID tag 12(2) and is detected by the RFID tag 12(2) (task 90). In response, the RFID tag 12(2) sets the event bit 82(3) (task 92) and sets the event occurrence indicator bit 72(2) in the memory 22 of the RFID tag 12(2) (task 94). Thus, when the RFID reader 34 sends the third interrogation query 64(3), the RFID tag 12(2) responds with a query reply 62(2) (task 96) to the RFID reader 34, as previously described. The RFID reader 34 then instructs the specific RFID tag 12(2) (without having to make such request to the other RFID tags 12(1) and 12(N-1)-12(N)) to return the event bits 82(0)-82(X) so that the RFID reader 34 will be able to ascertain which event types 56 occurred and were detected in association with the RFID tag 12(2) (task 98). The RFID tag 12(2) returns all its event bits 82(0)-82(N) to the RFID reader 34 in response (task 99).

With continuing reference to FIG. 8, other tasks may then be instructed to be performed on the RFID tag 12(2) by the RFID reader 34, including any read and/or write tasks desired (block 100). Thereafter, after the RFID reader 34 has finished processing the event bits 82(0)-82(X) for the RFID tag 12(2), the RFID reader 34 sends an acknowledgment 68 for event type number 3 50(3) to the RFID tag 12(2) (task 102). In response, as previously described, the RFID tag 12(2) clears the event type number 3 50(3) from the event bit 82(3) (task 103) and clears the event occurrence indicator bit 72(2) (task 105). When the RFID reader 34 sends the fourth interrogation query 64(4) as illustrated in FIG. 8, because the event occurrence indicator bit 72(2) is cleared in the RFID tag 12(2), the RFID tag 12(2) does not communicate a query reply 62.

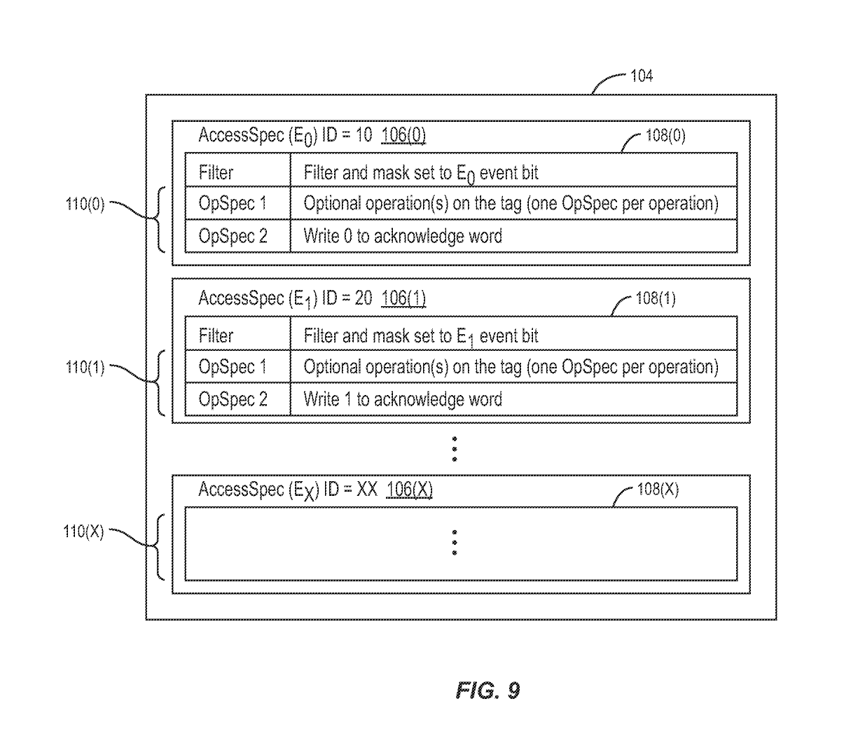

It may be desired to provide for the ability of the RFID reader 34 to be able to store events 50 reported by the RFID tags 12(1)-12(N) in the RFID system 10 in FIG. 8 for processing. For example, FIG. 9 is an exemplary low level reader protocol (LLRP) event table 104 that may be employed by the RFID reader 34 in the RFID system 10 in FIG. 8 to support servicing a single event 50 at one time reported by the RFID tag 12(1)-12(N). In this regard, the LLRP event table 104 contains an access specification (AccessSpec) 106(0)-106(X) for each event type 56 (E₀-E_{X}). Each access specification 106(0)-106(X) includes a filter field 108(0)-108(X) that contains a mask to be applied to the event bits 82(0)-82(X) to determine if the event type 56 for the AccessSpec 106(0)-106(X) is being reported for a given RFID tag 12(1)-12(N). One or more operational specifications (OpSpec) 110(0)-110(X) define what query replies 62 that the RFID reader 34 will carry out upon the receipt of the corresponding reported event type 56 for a given RFID tag 12(1)-12(N). Other filters not shown in FIG. 9 can be provided for operational specifications 110(2)-110(X).

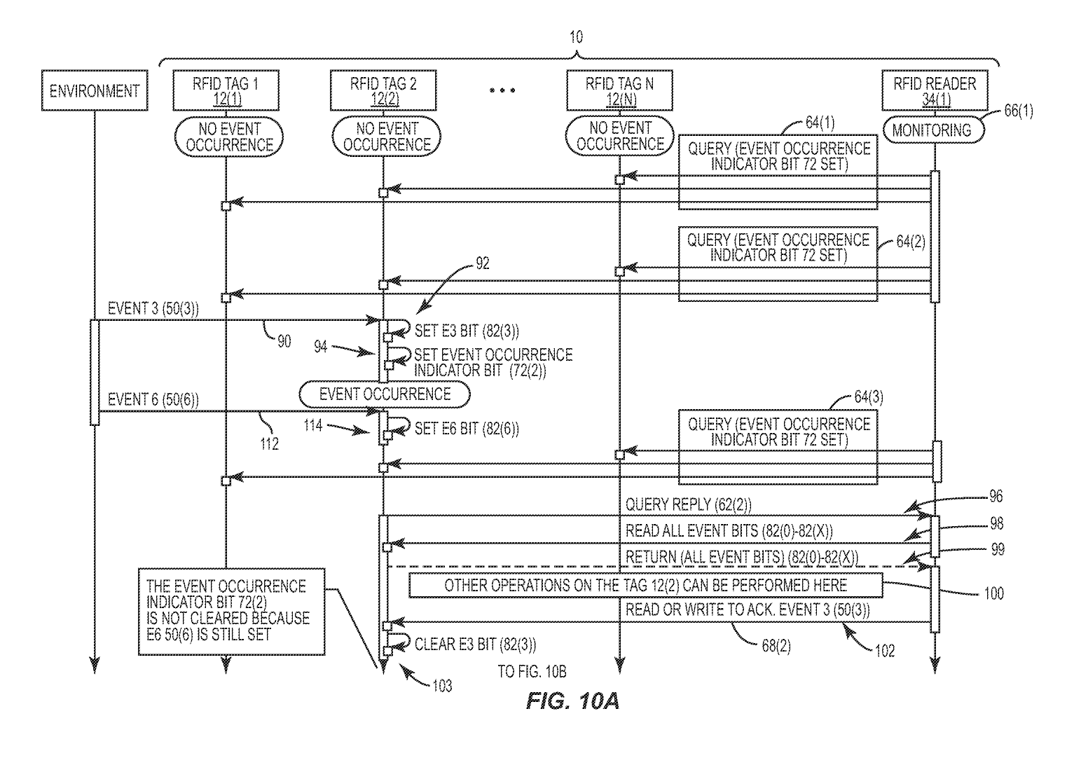

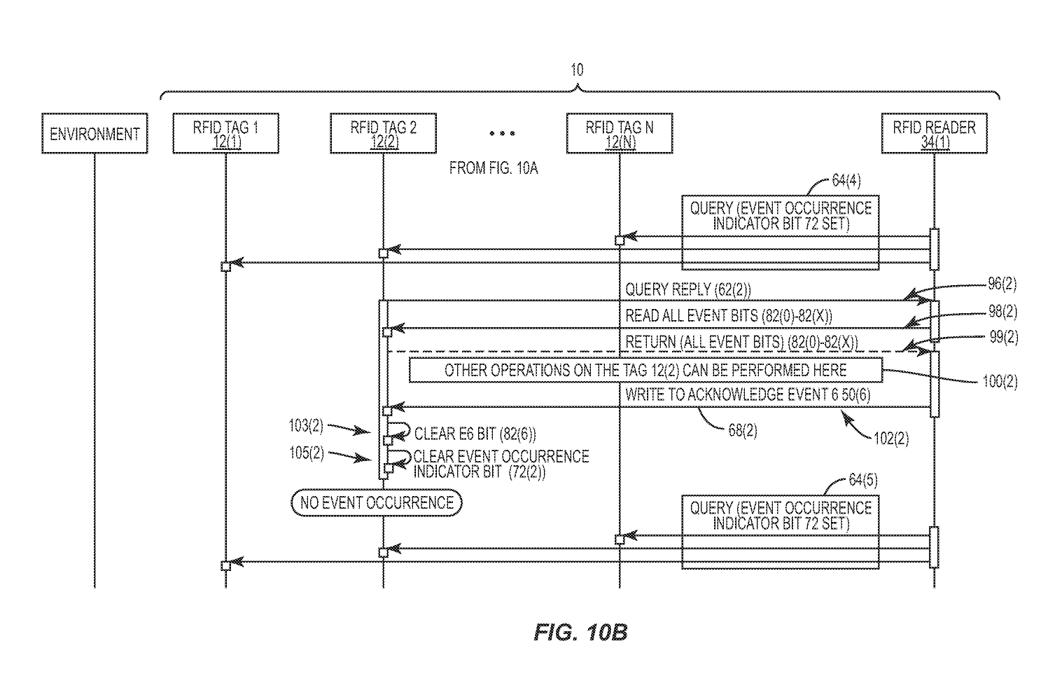

It may be desired to provide for the ability of the RFID reader 34 to be able to handle reporting and servicing of multiple events 50 from a RFID tag 12 employing combined event 50 processing as opposed to only processing one event 50 at a time, as provided in FIG. 8. In this regard, FIGS. 10A and 10B are schematic diagrams of another exemplary RFID tag event detection sequence. In this embodiment, multiple RFID tag event occurrences are detected by the RFID tag 12(2) before the events 50 can be processed by a RFID reader 34. The corresponding multiple events 50 are reported to a RFID reader 34(1) configured to service multiple events from the RFID tags 12(1)-12(N) that are present during a given interrogation query 64. In this embodiment, as discussed in more detail below, the RFID reader 34(1) is provided like the RFID reader 34 discussed above, but the RFID reader 34(1) is configured to receive a report and fully process one of the multiple detected events 50 in response to an interrogation query 64 before processing other detected events 50. Additional interrogation query(ies) 64 are provided to receive a report and process the other detected events 50.

In this regard, as illustrated in FIG. 10A, the same exemplary tasks and blocks regarding the first two interrogation queries 64(1) and 64(2) are performed as provided in FIG. 8 and thus are not re-described. However in this embodiment, two events 50(3) and 50(6) occur in association with the RFID tag 12(2) and are detected by the RFID tag 12(2). In this regard, the first event 50(3) is detected and the corresponding event bit 82(3) in the memory 22 of the RFID tag 12(2) is set in tasks 90-94, just as provided in FIG. 8. The event occurrence indicator bit 72(2) is set. Thereafter, a second event 50(6) is detected in association with the RFID tag 12(2), and the corresponding event bit 82(6) in the memory 22 of the RFID tag 12(2) is set in tasks 112 and 114, respectively. In response to the third interrogation query 64(3) by the RFID reader 34(1), tasks 96-100 are performed just as provided in FIG. 8 and previously described to process the first event 50(3). However, the event occurrence indicator bit 72(2) is not cleared as provided in task 105 in FIG. 8, and as noted in FIG. 10A. Only the event bit 82(3) is cleared in task 103, just as provided in FIG. 8. This is because the RFID tag 12(2) has a second detected event 50(6) that needs to be processed by the RFID reader 34(1). The RFID reader 34(1) will not process the second detected event 50(6) for the RFID tag 12(2) if the event occurrence indicator bit 72(2) is cleared.

Thereafter, with regard to FIG. 10B, the RFID reader 34(1) sends out a fourth interrogation query 64(4). But instead of receiving no query reply 62 as provided in FIG. 8, a second query reply 62(2) is communicated by the RFID tag 12(2) to the RFID reader 34(1) to report the second detected event 50(6) is still active (task 96(2)). Tasks 98(2)-102(2) are performed to process the second detected event 50(6) for the RFID tag 12(2) in the same manner as tasks 98-102 are performed to process the first detected event 50(3). Thereafter, the event bit 50(6) is cleared for the second detected event 50(6) in the RFID tag 12(2) (task 103(2)). The event occurrence indicator bit 72(2) is cleared since both detected events 50(3), 50(6) have been reported by the RFID tag 12(2) to the RFID reader 34(1) and processed by the RFID reader 34(1) (task 105(2)). Thereafter, the RFID reader 34(1) continues to send a next interrogation query 64(5) and continues to do so until a query reply 62 is received from at least one of the RFID tags 12(1)-12(N). Note that although FIGS. 10A and 10B are described with regard to detecting and reporting events 50 only from RFID tag 12(2), multiple events 50 can be detected and reported by more than one RFID tags 12.

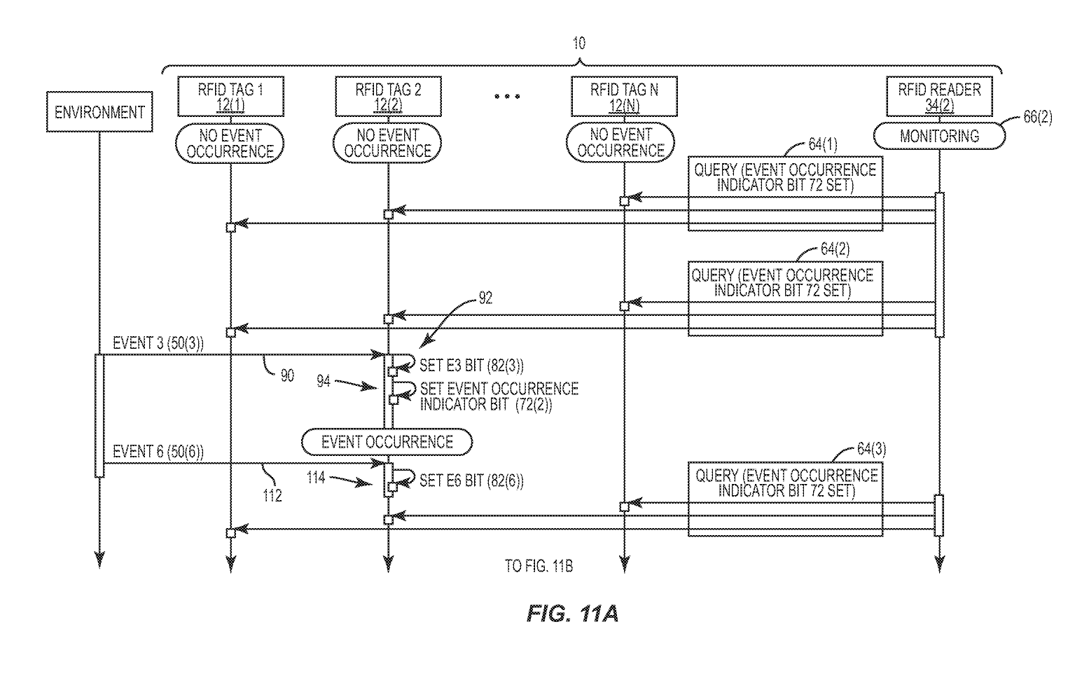

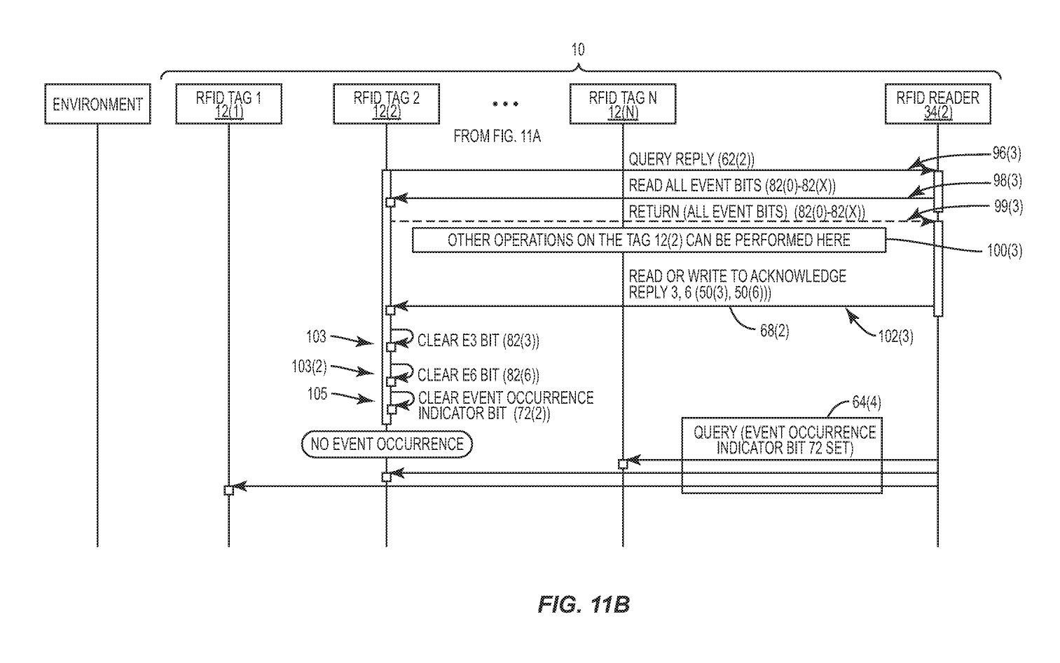

As discussed above with regard to FIGS. 10A and 10B, the RFID reader 34(1) is configured to receive a report and fully process one of the multiple detected events 50 in response to an interrogation query 64 before processing other detected events 50. Additional interrogation query(ies) 64 are provided to receive a report and process the other detected events 50. It may be desired to provide for a RFID reader 34 to receive a report and fully process multiple detected events 50 present during a single interrogation query 64 without having to wait and process subsequent detected events 50 present over additional interrogation queries 64. In this regard, FIGS. 11A and 11B are provided to illustrate an alternative exemplary RFID tag event detection sequence in this regard. In this embodiment, multiple events 50 are detected by a RFID tag 12 and reported to the RFID reader 34(2), wherein the events 50 are acknowledged in the RFID tag 12(2) contemporaneously. Subsequently, the event bits 82(3) and 82(6) for RFID tags 12(3), 12(6), respectively, are cleared. FIGS. 11A and 11B illustrate the same tasks and processing steps illustrated in FIGS. 10A and 10B, except tasks 96-102 are provided as tasks 96(3)-102(3), where both events 50(3) and 50(6) are both processed by the RFID reader 34(2). Thus, as illustrated in FIGS. 11A and 11B, the RFID tag 12(2) can acknowledge the write to acknowledge events 68 for both event bits 82(3) and 82(6) contemporaneously in task 102(3), and clear both event bits 82(3) and 82(6) in task 102(3) before the event interrupt indicator bit 72(2) is cleared in task 105.

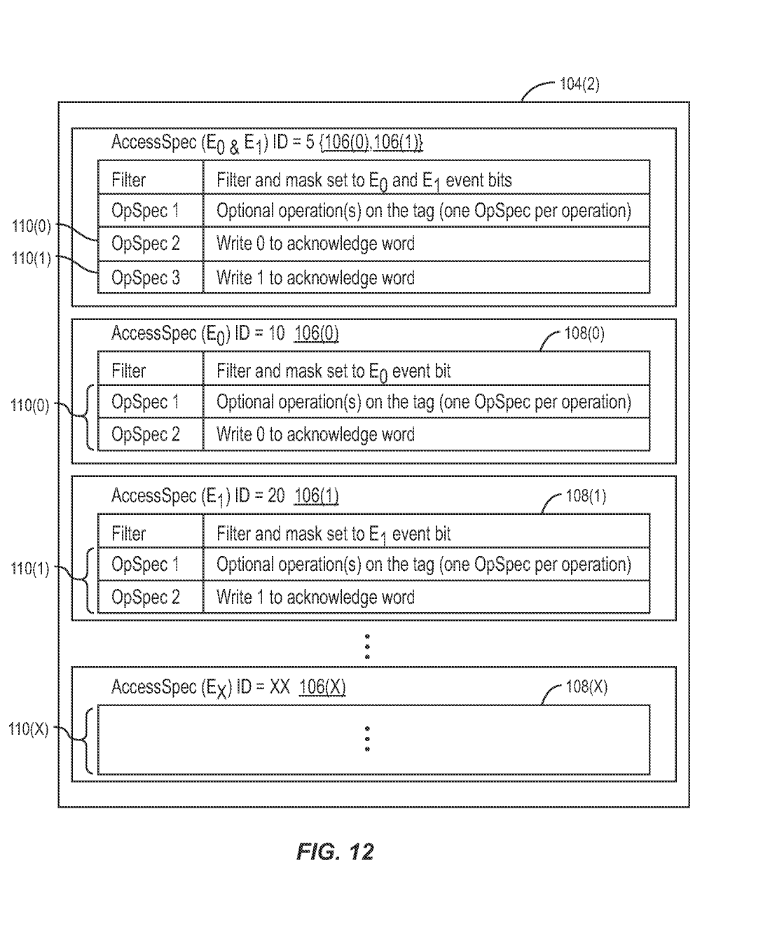

In one embodiment, the ability of the RFID reader 34(2) in FIGS. 11A and 11B to be able to process multiple events 50 in response to one interrogation query 64 is provided in FIG. 12. In this regard, FIG. 12 is an exemplary low level reader protocol (LLRP) event table 104(2) that may be employed by the RFID reader 34(2) in FIGS. 11A and 11B to support servicing multiple events 50 reported by the RFID tags 12(1)-12(N). Like the LLRP event table 104 in FIG. 9, the LLRP event table 104(2) contains an access specification (AccessSpec) 106(0)-106(X) for each combination of event types 56 (E₀-E_{X}). Operational specifications for combined event types 56 detected contemporaneously can appear first in the LLRP event table 104(2) before operational specifications for single event types 56 are provided. Each access specification 106(0)-106(X) includes a filter field 108(0)-108(X) that contains a mask to be applied to the event bits 82(0)-82(X) to determine if the particular combination of event types 56 for the AccessSpec 106(0)-106(X) is being reported for a given RFID tag 12(1)-12(N). One or more operational specifications (OpSpec) 110(0)-110(X) define what query replies 62 the RFID reader 34 will carry out upon the receipt of the corresponding reported combination of event types 56 for a given RFID tag 12(1)-12(N). However, in this LLRP event table 104(2), access specifications are supported for a combination of multiple event types 56, as illustrated by the combined access specification 106(0), 106(1) as the first entry in the LLRP event table 104(2). In this entry, if events 56(0) and 56(1) (E₀ and E₁) are reported during the same interrogation query 64, the RFID reader 34(2) can process these multiple events according to the corresponding entry in the LLRP event table 104(2) that provides operational specifications to process both events 56(0) and 56(1). Other filters not shown in FIG. 12 can be provided for operational specifications 110(2)-110(X).

Any functionalities disclosed in any embodiments may be incorporated or provided in any other embodiments with suitable circuitry and/or devices. Although the illustrated embodiments are directed to components, wherein RFID-enabled versions of the components, including ICs and IC chips, employ passive RFID tags, further embodiments include one or more semi-passive or active RFID tags depending upon the particular functionality of the RFID tag system desired. The RFID tags can also be employed in any application desired, including but not limited to fiber optic connectors, optical fiber cables and cable assemblies, fiber optic cable management hardware and devices, electrical connectors, medical devices, pharmaceutical containers, credit cards, employee badges, facility entry devices, fluid couplings, beverage dispensing containers, industrial controls, environmental monitoring devices, connection of consumer electronics, electronics assemblies and subassemblies, containers and lids, doors and doorframes, windows and sills, and many other applications.

Those of skill in the art would further appreciate that the various illustrative logical blocks, modules, circuits, and algorithms described in connection with the embodiments disclosed herein may be implemented as electronic hardware, instructions stored in memory or in another computer-readable medium and executed by a processor or other processing device, or combinations of both. Electrical coupling can include both internal and external coupling or accessibility. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a processor, a DSP, an Application Specific Integrated Circuit (ASIC), an FPGA or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The embodiments disclosed herein may be embodied in hardware and in instructions that are stored in hardware, and may reside, for example, in volatile memory, non-volatile memory, Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. It is to be understood that the operational steps illustrated in the flow chart diagrams may be subject to numerous different modifications as will be readily apparent to one of skill in the art. Those of skill in the art would also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Many modifications and other embodiments of the embodiments set forth herein will come to mind to one skilled in the art to which the embodiments pertain having the benefit of the teachings presented in the foregoing descriptions and the associated drawings. Therefore, it is to be understood that the description and claims are not to be limited to the specific embodiments disclosed and that modifications and other embodiments are intended to be included within the scope of the appended claims. It is intended that the embodiments cover the modifications and variations of the embodiments provided they come within the scope of the appended claims and their equivalents. Although specific terms are employed herein, they are used in a generic and descriptive sense only and not for purposes of limitation.

What is claimed is:

1. A radio-frequency identification (RFID) tag, comprising:
an integrated circuit (IC);
an antenna electrically coupled to the IC, the antenna configured to receive wireless RF signals;
a memory accessible to the IC, the memory comprising one or more event occurrence indicators; and
one or more event sensors electrically coupled to the IC and configured to sense an occurrence of one or more events and indicate the occurrence of the one or more events to the IC;
wherein the IC is configured to set the one or more event occurrence indicators in response to occurrence of the one or more events.

2. The RFID tag of claim 1, wherein at least one event among the one or more events is comprised of at least one tangible event.

3. The RFID tag of claim 1, wherein the one or more event sensors are each configured to detect at least one event comprised from the group consisting of a RFID tag power up, a power outage, a RFID tag error condition, a RFID tag connection to another RFID tag, a RFID tag disconnect from another RFID tag, identification information exchange with another RFID tag, a heartbeat timer, a contact closure, a switch activation, a switch deactivation, an analog signal threshold crossing, a digital input high, and a digital input low.

4. The RFID tag of claim 1 comprised of an active RFID tag.

5. The RFID tag of claim 1 comprised of a passive RFID tag.

6. The RFID tag of claim 5, further comprising a passive energy storage device chargeable by energy from the wireless RF signal, the passive energy storage device dischargeable to electrically power the RFID tag.

7. The RFID tag of claim 1, further comprising a visual indicator electrically coupled to the IC, the IC further configured to activate the visual indicator in response to the occurrence of the at least one event.

8. The RFID tag of claim 7, further comprising a passive energy storage device chargeable by energy from the wireless RF signal, the passive energy storage device dischargeable to electrically power the visual indicator.

9. The RFID tag of claim 1 configured to report a status of the one or more event occurrence indicators to a RFID reader.

10. The RFID tag of claim 1 configured to report one or more event occurrence types corresponding to the one or more events to a RFID reader.

11. The RFID tag of claim 1, wherein the IC is configured to clear the one or more event occurrence indicators in response to receipt of one or more event occurrence indicator acknowledgements from a RFID reader.

12. The RFID tag of claim 1, wherein the one or more event occurrence indicators are each comprised of an event occurrence bit.

13. The RFID tag of claim 1, wherein the memory further comprises a plurality of event type occurrence indicators each indicative of the occurrence of a particular event type.

14. The RFID tag of claim 13, further configured to report at least one particular event type occurrence set in at least one of the plurality of event type occurrence indicators.

15. The RFID tag of claim 13, wherein the memory further comprises a plurality of event type disable indicators each individually configured to be set to indicate at least one corresponding event type occurrence indicator among the plurality of event type occurrence indicators being disabled.

16. The RFID tag of claim 15, wherein the IC is further configured to set the one or more event occurrence indicators based on one or more of the plurality of event type occurrence indicators being set and a corresponding one of the plurality of event type disable indicators not being set.

17. A method of a radio-frequency identification (RFID) tag reporting an event occurrence relating to the RFID tag, comprising:
sensing an occurrence of one or more events in one or more event sensors electrically coupled to an integrated circuit (IC) of a RFID tag;
indicating the occurrence of the one or more events to the IC; and
setting one or more event occurrence indicators in a memory accessible to the IC in response to the occurrence of the one or more events.

18. The method of claim 17, wherein the sensing of the occurrence of one or more events comprises sensing of the occurrence of at least one tangible event in the one or more event sensors electrically coupled to the IC.

19. The method of claim 17, further comprising:
charging a passive energy storage device in the RFID tag from energy received by an antenna electrically coupled to the IC; and
discharging the passive energy storage device to electrically power at least one component of the RFID tag.

20. The method of claim 17, further comprising activating a visual indicator electrically coupled to the IC in response to the occurrence of the one or more events.

21. The method of claim 17, further comprising reporting a status of the one or more event occurrence indicators to a RFID reader.

22. The method of claim 17, further comprising storing one or more event occurrence types corresponding to the one or more events in the memory.

23. The method of claim 22, further comprising reporting the one or more event occurrence types to a RFID reader.

24. The method of claim 17, further comprising clearing the one or more event occurrence indicators in response to receipt of one or more corresponding event occurrence indicator acknowledgements from a RFID reader.

25. The method of claim 22, further comprising setting one or more event type disable indicators to disable reporting of the corresponding one or more event occurrence types to a RFID reader.

26. A radio-frequency identification (RFID) reader, comprising:
a controller electrically coupled to a transmitter, the controller configured to control the transmitter to transmit wireless RF signals through an antenna electrically coupled to the transmitter;
a memory accessible to the controller;
the controller configured to:
send a query requesting event occurrence indicator status from a plurality of RFID tags;
receive at least one reply from a subset of RFID tags among the plurality of RFID tags, each of the subset of RFID tags having one or more event occurrence indicators set indicative of an occurrence of one or more events associated with a respective RFID tag; and
request event occurrence information from at least one of the subset of RFID tags having the at least one of the one or more event occurrence indicators set.

27. The RFID reader of claim 26, wherein the controller is further configured to wait for the reply from at least one of the subset of RFID tags before requesting the event occurrence information.

28. The RFID reader of claim 27, wherein the controller is configured to request the event occurrence information from at least one of the subset of RFID tags only after receiving the reply from the at least one of the subset of RFID tags.

29. The RFID reader of claim 28, wherein the controller is configured to send a single request for the event occurrence information to all of the subset of RFID tags only after receiving the reply from at least one of the subset of RFID tags.

30. The RFID reader of claim 28, wherein the controller is configured to individually request the event occurrence information from each of the subset of RFID tags only after receiving the reply from at least one of the subset of RFID tags.

31. The RFID reader of claim 26, wherein the controller is further configured to repeat sending the query requesting event occurrence indicator status from a plurality of RFID tags.

32. The RFID reader of claim 26, wherein the controller is further configured to receive the event occurrence information from the subset of RFID tags having at least one of the one or more event occurrence indicators set.

33. The RFID reader of claim 28, wherein the controller is further configured to service the received event occurrence information from at least one of the subset of RFID tags.

34. The RFID reader of claim 33, wherein the controller is configured to service the received event occurrence information by being configured to store the received event information from at least one of the subset of RFID tags in the memory.

35. The RFID reader of claim 33, wherein the controller is configured to service the received event occurrence information by being configured to communicate the received event occurrence information from at least one of the subset of RFID tags to a client system.

36. The RFID reader of claim 26, wherein the controller is further configured to receive a command from a client system to send the query requesting event occurrence indicator status from a plurality of RFID tags.

37. The RFID tag of claim 33, wherein the controller is further configured to acknowledge the event occurrence information from at least one of the subset of RFID tags.

38. The RFID reader of claim 37, wherein the controller is further configured to service event occurrence information for one event from a RFID tag among the subset of RFID tags and acknowledge the one event to the RFID tag, before servicing event occurrence information for another event.

39. The RFID reader of claim 37, wherein the controller is further configured to service the event occurrence information for one event from a RFID tag among the subset of RFID tags and acknowledge the one event before servicing other events.

40. The RFID reader of claim 39, wherein the controller is further configured to acknowledge the one event before servicing other events from the RFID tag.

41. The RFID reader of claim 39, wherein the controller is further configured to acknowledge the one event before servicing other events from other RFID tags among the subset of RFID tags.

42. The RFID reader of claim 39, wherein the controller is further configured to service the event occurrence information for multiple events before acknowledging the multiple events.

43. The RFID reader of claim 26, wherein the memory further comprises an event detection data structure configured to store a single event occurrence from the event occurrence information for each of a plurality of RFID tags.

44. The RFID reader of claim 43, wherein the event detection data structure is configured to store a plurality of event occurrences from the event occurrence information for each of a plurality of RFID tags.

45. The RFID reader of claim 43, wherein the event detection data structure is structured according to Low Level Reader Protocol (LLRP) and configured to store at least one event occurrence from the event occurrence information for each of a plurality of RFID tags.

46. A method of a radio-frequency identification (RFID) reader reading event occurrences from RFID tags, comprising:
wirelessly sending a query from a transmitter electrically coupled to an antenna requesting event occurrence indicator status from a plurality of RFID tags;
receiving at least one reply from a subset of RFID tags among the plurality of RFID tags having one or more event occurrence indicators set indicative of an occurrence of one or more events; and
requesting event occurrence information from at least one of the subset of RFID tags having at least one event occurrence indicator set among the one or more event occurrence indicators for the RFID tag.

47. The method of claim 46, further comprising waiting for the reply from at least one RFID tag among the subset of RFID tags before requesting the event occurrence information.

48. The method of claim 46, further comprising receiving the event occurrence information from at least one RFID tag among the subset of RFID tags having the event occurrence indicator set.

49. The method of claim 46, further comprising servicing the received event occurrence information from at least one RFID tag among the subset of RFID tags.

50. The method of claim 49, further comprising acknowledging the event occurrence information from the at least one RFID tag among the subset of RFID tags.

51. The method of claim 49, further comprising servicing the event occurrence information for one event from a RFID tag among the subset of RFID tags and acknowledging the one event to the RFID tag, before servicing event occurrence information for another event.

52. The method of claim 49, further comprising servicing the event occurrence information for one event from a RFID tag among the subset of RFID tags and acknowledging the one event before servicing other events from the other RFID tags among the subset of RFID tags.

53. The method claim 49, further comprising servicing the event occurrence information for multiple events before acknowledging the multiple events.

54. A radio-frequency identification (RFID) system, comprising:
a plurality of RFID tags, each comprising:
an integrated circuit (IC);
at least one event sensor electrically coupled to the IC and configured to sense the occurrence of one or more events and indicate the occurrence of the one or more events to the IC;
wherein the IC is configured to:
set one or more event occurrence indicators in response to occurrence of the one or more events; and
report a status of the one or more event occurrence indicators to a RFID reader; and
a RFID reader, comprising:
a controller electrically coupled to a transmitter, the controller configured to control the transmitter to transmit wireless RF signals through an antenna;
the controller configured to:
send a query requesting event occurrence indicator status from the plurality of RFID tags;
receive at least one reply from the plurality of RFID tags indicating whether at least one of the one or more event occurrence indicators for the RFID tag is set; and
if the one or more event occurrence indicators is set, request event occurrence information from a subset of the plurality of RFID tags that have at least one event occurrence indicator set among the one or more event occurrence indicators for the RFID tag.
